(19) United States
(12) Patent Application Publication
(10) Pub. No.: US 2022/0137781 A1
(43) Pub. Date: May 5, 2022

(54) TOUCHSCREEN CALIBRATION CIRCUIT

(71) Applicant: Hewlett-Packard Development Company, L.P., Spring, TX (US)

(72) Inventors: Wei-Chou Chen, Taipei City (TW); Chen-Mu Chang, Taipei City (TW); Wong Haoping, Taipei City (TW); Yu Cheng Tsai, Taipei City (TW); Jyun-Cheng Lin, Taipei City (TW)

(73) Assignee: Hewlett-Packard Development Company, L.P., Spring, TX (US)

(21) Appl. No.: 17/419,321

(22) PCT Filed: Jul. 24, 2019
(86) PCT No.: PCT/US2019/043173

§ 371 Date: Jun. 29, 2021

(51) Int. Cl. G06F 3/041

(52) U.S. Cl. CPC G06F 3/04182; G06F 3/0412; G06F 3/04184

(57) ABSTRACT

An apparatus can include a calibration circuit to determine a backlight status of a display device based on a detected difference in a noise level corresponding to the display device. The calibration circuit can perform an operation to calibrate a touchscreen coupleable to the display device based on the determined backlight status.

### BACKGROUND

Display devices, such as liquid-crystal displays, can exhibit different noise levels when operated in different power states. For example, a noise level corresponding to a display device can be different when the display device is in a powered-on state than when the display device is in a powered off state. These different noise levels can affect the behavior of a touchscreen that can be used to interface with the display device.

### BRIEF DESCRIPTION OF THE DRAWINGS

FIG. 1 illustrates an example of an apparatus including a touchscreen and calibration circuit consistent with the disclosure.

FIG. 2 illustrates a flow diagram corresponding to operation of a touchscreen calibration circuit consistent with the disclosure.

FIG. 3 illustrates an example plot showing display device noise against time consistent with the disclosure.

FIG. 4 illustrates an example of a method corresponding to a touchscreen calibration circuit consistent with the disclosure.

FIG. 5 illustrates an example of a calibration circuit including a processing resource and a memory resource storing non-transitory machine-readable instructions consistent with the disclosure.

### DETAILED DESCRIPTION

A display device can be used to display information such as pictures, text, video, or other information that can be viewed by, for example, a user of the display device. As used herein, the term “display device” refers to a television, computer monitor, instrument panel, or other device that displays information. An example of a display device can be a liquid-crystal display, which utilizes the light-modulating properties of liquid crystals to display information. Display devices can be used in a wide range of applications, such as watches, smartphones, computers, laptops, phablets, digital cameras, internet-of-things enabled-devices, video game devices, and/or billboards, among others.

Some display devices can receive an input from a touchscreen. As used herein, the term “touchscreen” refers to an input device that is layered on top of a display device. A touchscreen can facilitate operation of a display device by converting an input (e.g., a simple touch or multi-touch gesture) into a signal that controls the display of the display device such that information displayed on the display device is manipulated. Touchscreens can allow a user of a computing device to interact directly with the information displayed on the display device as opposed to using a peripheral device, such as a pointing device or keyboard to interact with the information displayed on the display device.

Display devices can exhibit different noise levels based on a power mode in which the display device is operating. As used herein, the term “noise” refers to electromagnetic interference (EMI) that can cause a disturbance in the display device due to electromagnetic induction, electromagnetic coupling, and/or conduction, Such disturbances can, if left unchecked, lead to unintended effects such as degradation of performance of the display device and/or a touchscreen that may be coupled to the display device. For example, noise exhibited by a display device can reduce the performance or efficacy of a touchscreen that is used to operate the display device.

Examples of ways in which noise exhibited by a display device can reduce the performance of a touchscreen can be realized in the form of “ghost touch” effects in which a portion of the touchscreen may be activated in the absence of a touch input, non-responsive touchscreen behavior in which the touchscreen, and hence, the display device, do not accurately respond to a touch input, and/or reduced refresh rates of the display device, which can lead to information displayed on the display device appearing to be choppy and/or fuzzy, among others.

In some approaches, the effects of display device noise, especially in relation to touchscreen behavior, can be taken into account through the use of instructions (e.g., firmware instructions, microcode instructions, etc.) that seek to mitigate the effects of display device noise. However, such instructions are often complex, thereby consuming large amounts of processing resources and/or time to execute. Further, as such firmware instructions become increasingly complex due to advancements in display device technology, a greater amount of processing resources used to execute such instructions, as well as memory resources to store increasingly complex instructions to account for display device noise, can increase thereby increasing the footprint of circuitry used by the display device and, as a result, the manufacturing costs associated therewith.

In other approaches, clocking circuitry that controls display of information on the display device can be disabled for predetermined periods of time in an attempt to mitigate the effects of display device noise. However, such approaches can employ additional circuitry within the display device that can produce additional noise that may not be present in the display device otherwise. Similar to the approaches described above, approaches in which additional clocking circuitry is employed to mitigate the effects of noise on the display device can increase the footprint of circuitry used by the display device and, as a result, the manufacturing costs associated therewith.

Further, because different display devices can exhibit different noise characteristics, some approaches focus specifically on display device noise mitigation specific to a particular display device. For example, different display devices can include different circuitry and/or circuit configurations, which can lead to the exhibition of different noise characteristics when compared to a different display device. Such approaches can employ proprietary methods of noise mitigation, which may not allow for integration across platforms and may be non-ideal for different touchscreens.

Moreover, as a display device ages, the noise levels exhibited by the display device can change. For example, due to degradation of the display device screen and/or other components of the display device, noise levels exhibited by the display device can increase over time and use of the display device. In addition, the presence of other equipment that generates EMI can cause the noise levels of the display device to change. In some approaches, these variables are not considered and, as the display device ages, reduced performance or accuracy of the display device can therefore be observed.

In contrast, examples described herein are directed to hardware circuitry (e.g., a “calibration circuit”) resident on a touchscreen that can be operated to calibrate the touchscreen and/or display device in response to a change in a status (e.g., a power mode status, a backlight status, etc.) of the display device. For example, the calibration circuit can monitor a backlight status of a display device to which the touchscreen is coupled. In response to the change in backlight status, the calibration circuit can perform an operation to calibrate the touchscreen based on a detected noise level of the display device. By performing the calibration in response to the changed backlight status of the display device, examples described herein can provide handling of display device noise across different display devices. Further, by performing a calibration operation using calibration circuitry resident on the touchscreen, examples herein can allow for the mitigation of adverse effects on the touchscreen due to degradation of the display device in comparison to some approaches because the touchscreen can be re-calibrated when the display device is powered on, thereby providing a fresh calibration of the touchscreen based on the specific noise behavior of the display device each time the display device is powered on. As used herein, the term “resident on” refers to something that is physically located on a particular component. For example, the calibration circuit being “resident on” the touchscreen refers to a condition in which the calibration circuit is physically located on or within the touchscreen. The term “resident on” may be used interchangeably with other terms such as “deployed on” or “located on,” herein.

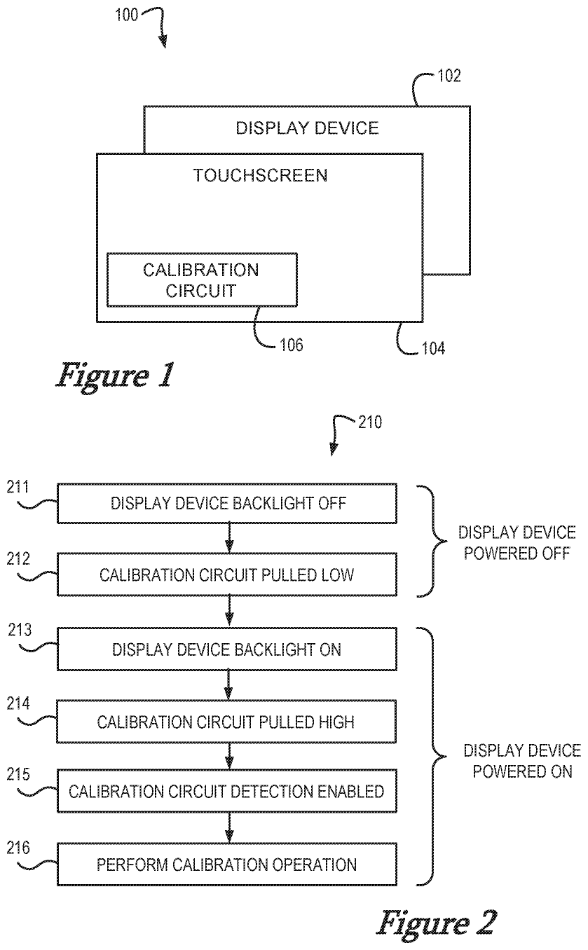

FIG. 1 illustrates an example of an apparatus 100 including a touchscreen 104 and calibration circuit 106 consistent with the disclosure. As shown in FIG. 1, the calibration circuit 106 is resident on the touchscreen 104. The touchscreen 104 can be coupleable to the display device 102.

The display device 102 can, as discussed above, be a television, computer monitor, instrument panel, or other device that displays information. The touchscreen 104 can be an input device that is layered on top of a display device and serves to allow interaction between a user and the display device, In some examples, the touchscreen 104 can be a capacitive touchscreen that can sense input from a finger, a stylus, capacitive pen, specialized glove, etc. Examples are not so limited, however, and in some examples, the touchscreen 104 can be a resistive touchscreen that detects an applied pressure to allow interaction between a user and the display device 102.

In some examples, the calibration circuit 106 can determine a backlight status of the display device 102 based on a detected difference in a noise level corresponding to the display device 102. For example, the calibration circuit 106 can detect that a change in the noise level of the display device 102 has occurred in response to a change in the backlight status of the display device 102. The backlight status of the display device 102 can be based on the power status of the display device 102. For example, the display device 102 can have a first backlight status associated therewith when the display device 102 is in a powered off state and a second backlight status associated therewith when the display device 102 is in a powered-on state. As used here, the term “backlight status” refers to an on or off condition of a component of the display device 102 that provides illumination to the display device 102 thereby allowing the display device 102 to display information on the display device 102. In some examples, when the backlight status of the display device 102 is in a powered off state, the display device 102 may not display information. Conversely, when the backlight status of the display device 102 is in a powered-on state, the display device 102 may display information.

The change in noise level corresponding to the display device 102 can correspond to the backlight status of the display device 102. For example, the change in noise level corresponding to the display device 102 can correspond to the display device 102 experiencing a change in a power status. In some examples, the display device 102 can exhibit a first noise level when the display device 102 is powered off (e.g., when the backlight of the display device 102 is powered off) and a second noise level when the display device 102 is powered on (e.g., when the backlight of the display device 102 is powered on). In some examples, the noise level associated with the display device 102 being in a powered-on state can be greater than the noise level associated with the display device 102 being in a powered off state.

The calibration circuit 106 can, in some examples, perform an operation to calibrate the touchscreen 104 based on the determined backlight status. As used herein, the term “calibrate” or “calibration” refers to an operation to establish a relation between values, use the relation between the values to determine correction factors, and apply the correction factors to adjust the behavior of something. As a non-limiting example, a calibration operation can include establishing a relation between an amount of noise exhibited by a display device 102 and behavior of a touchscreen 104 to determine a correction factor to be applied to the touchscreen 104 and applying the correction factor to the touchscreen 104 to increase performance of the touchscreen 104.

In some examples, the calibration circuity 106 can operate in a first power mode while the backlight status of the display device 102 is in a first state and a second power mode while the backlight status of the display device 102 is in a second state. The first state, and hence the first power mode of the display device 102, can correspond to the display device 102 being powered off, while the second state, and hence the second power mode of the display device 102, can correspond to the display device 102 being powered on.

The calibration circuit 106 can, in some examples, perform the operation to calibrate the touchscreen 104 within a predetermined threshold time period after the backlight status is determined. For example, as described in more detail in connection with FIG. 2, herein, the calibration circuit 106 can be powered on for a predetermined threshold period of time and can perform the calibration operation within this predetermined threshold period of time. In some examples, this can allow for the calibration circuit 106 to consume no greater than a threshold amount of power during performance of the calibration operation.

In some examples, the operation to calibrate the touchscreen 104 can include performance of an operation to calibrate a base reference capacitive sensing parameter corresponding to the touchscreen 104. For example, if the touchscreen 104 is a capacitive touchscreen (e.g., a touchscreen that uses the conductive touch of a human finger or a specialized device for input), the calibration circuit 106 can perform the operation to calibrate the touchscreen 104 to a base reference capacitive sensing parameter as part of the operation to calibrate the touchscreen 104. By calibrating the touchscreen 104 to a base reference capacitive sensing parameter, the calibration circuit 106 can effectively reset the sensitivity of the touchscreen 104 when the display device 102 is power cycled, thereby optimizing the sensitivity and/or accuracy of the touchscreen 104. As used herein, the term “base reference capacitive sensing parameter” refers to a parameter that corresponds to a state in which a capacitive touchscreen is in a lowest electrical energy state. For example, a base reference capacitive sensing parameter can be a parameter that indicates that the touchscreen 104 has been calibrated to reduce noise effects imparted thereto by the display device 102. As used herein, the term “power cycled” refers to the act of changing a power state of a piece of equipment, such as the display device 102. For example, “power cycling,” as used herein refers to the act of turning the display device on (e.g., to a powered on state) from a powered off state, and vice versa.

In a non-limiting example, the display device 102, the touchscreen 104, and the calibration circuit 106 can be provided in the form of a system. In such examples, the display device 102 can be a liquid-crystal display (LCD) device and the touchscreen 104 can be couplable to the display device 102. As described above, the calibration circuit 106 can be located resident on the touchscreen 104.

Continuing with the example in which the display device 102, the touchscreen 104, and the calibration circuit 106 are provided in the form of a system, the calibration circuit 106 may determine that a change in a backlight status of the liquid-crystal display device 102 has occurred and perform an operation to calibrate the touchscreen 104 based on the determined change in the backlight status. As described above, the calibration circuit 106 can determine that the change in the backlight status of the liquid-crystal display device 102 has occurred in response to a determination that a change in a power state of the liquid-crystal display device 104 has occurred.

The calibration circuit 106 can determine that the change in the backlight status of the liquid-crystal display device 102 has occurred based on detection of a change in a noise level corresponding to the liquid-crystal display device 102. For example, because the liquid-crystal display device 102 may exhibit different noise levels between a powered off and a powered on state, when the liquid-crystal display device 102 is power cycled, the noise level corresponding thereto may change.

The calibration circuit 106 can perform an operation to calibrate a base reference capacitive sensing parameter corresponding to the touchscreen 104 as part of the operation to calibrate the touchscreen 104. As described above, by calibrating the touchscreen 104 to a base reference capacitive sensing parameter, the calibration circuit 106 can effectively reset the sensitivity of the touchscreen 104 when the liquid-crystal display device 102 is power cycled, thereby increasing the sensitivity and/or accuracy of the touchscreen 104 based on the detected noise level of the liquid-crystal display device 102.

In some examples, the calibration circuit 106 can operate in a first power mode prior to the determination that the change in the backlight status of the liquid-crystal display device 102 has occurred and operates in a second power mode subsequent to the determination that the change in the backlight status of the liquid-crystal display device 102 has occurred. For example, when the calibration circuit 106 does not detect an active backlight status or greater than a threshold noise output from the liquid-crystal display device 102, the calibration circuit 106 can remain in a powered low (or off) mode to conserve power. Once the calibration circuit 106 detects an active backlight status or greater than a threshold noise output from the liquid-crystal display device 102, the calibration circuit 106 can enter a powered high (or on) mode and begin performance of the operations ascribed to the calibration circuit 106 herein.

FIG. 2 illustrates a flow diagram 210 corresponding to operation of a touchscreen calibration circuit consistent with the disclosure. While the operations of blocks 211 and 212 are performed, a display device (e.g., the display device 102 illustrated in FIG. 1) can be powered off and while the operations of blocks 213, 214, 215, and 216 are performed, the display device can be powered on.

At block 211 when the display device is powered off, the display device backlight can be powered off. While the display device is powered off, the calibration circuit (e.g., the calibration circuit 106 illustrated in FIG. 1) can be pulled low (e.g., can be powered off). As described above, by maintaining a powered off state of the calibration circuit while the display device and/or the display device backlight are powered off, power used in operation of the calibration circuit can be reduced.

At block 213 when the display device is powered on, the display backlight can be powered on. In response to the display device being powered on and/or the display device backlight being powered on, the calibration circuit can, at block 214, be pulled high (e.g., can be powered on).

Once the calibration circuit is pulled high at block 214, the calibration circuit detection can be enabled at block 215. Accordingly, at block 215 the calibration circuit can begin performing the operations described herein. For example, once the calibration circuit detection is enabled at block 215, the calibration circuit can detect a noise level associated with the display device.

At block 216, the calibration circuit can perform a calibration operation. For example, at block 216, the calibration circuit can perform a calibration operation to calibrate a touchscreen (e.g., the touchscreen 104 illustrated in FIG. 1), etc. As described herein, the calibration operation can include calibrating the touchscreen based on the noise level exhibited by the display device and/or the backlight status of the display device.

In some examples, the calibration operation can include reducing errors exhibited by the touchscreen as a result of electrical noise triggered by thermal and/or electromagnetic effects. For example, touchscreens can be susceptible to electrical noise introduced during analog-to-digital conversion due to impedance effects associated with analog-to-digital conversion circuitry used to operate the touchscreen. To combat these effects, the calibration operation can include accounting for electrical noise present in the touchscreen and either reducing the amount of electrical noise present in the touchscreen (e.g., by driving the circuitry of the touchscreen to low or ground reference potential) or calibrating the touchscreen to account for the electrical noise present in the touchscreen.

In addition to, or in the alternative, the calibration operation can include an operation to align a coordinate system utilized by the touchscreen such that the coordinate system of the touchscreen aligns with a coordinate system used by the display device. Because the coordinate system used by the touchscreen and/or the display device can become skewed or rotated as a result of noise exhibited by the display device and/or a backlight status of the display device, by calibrating the touchscreen coordinate system to the display device coordinate system based on the noise and/or backlight status of the display device, a reduction in errors exhibited by the touchscreen can be realized in contrast to approaches that do not employ the calibration circuitry described herein.

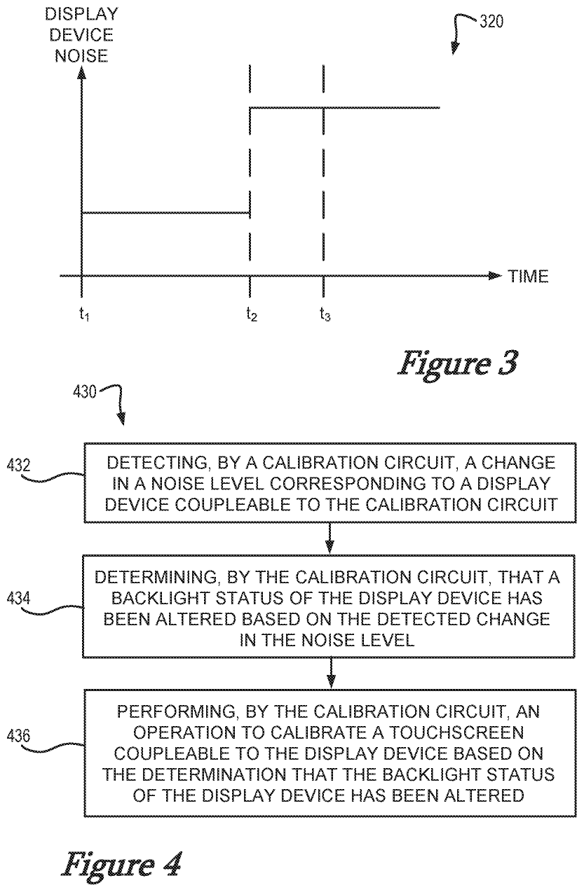

FIG. 3 illustrates an example plot 320 showing display device noise against time consistent with the disclosure. In the example plot 320 illustrated in FIG. 3, display device noise (e.g., a noise level exhibited by a display device such as the display device 102 illustrated in FIG. 1) is shown as a function of time.

At time t₁, the display device noise can exhibit a base noise level. The base noise level can correspond to the display device being a powered off state. In some examples, the base noise level may correspond to the absence of noise exhibited by the display device, however, in some examples, the base noise level may not be exactly zero (e.g., no noise). For example, it is possible for the display device to exhibit some non-vanishing (e.g., non-zero) base level of noise even when the display device is powered off. This can be due to stray capacitance in the display device or residual electrical charge in the display device, among other effects. However, as illustrated in FIG. 3, the base noise level illustrated at t₁ is less than the noise level exhibited at t₂ and beyond.

At time t₂, the display device can be powered on. As described above, a backlight associated with the display device can be powered on in response to the display device being powered on. As shown in FIG. 3, in response to the display device being powered on, at t₂, the noise level increases to a higher level than the base noise level shown prior to time t₂.

In response to the display device being powered on at time t₂, a calibration circuit (e.g., the calibration circuit 106 illustrated in FIG. 1, herein) can be pulled high as described in connection with FIG. 2, herein. It is noted that, as described in connection with FIG. 2, herein, the calibration circuit can be pulled low prior to time t₂.

In response to being pulled high (e.g., being powered on), the calibration circuit detection can be enabled as described in connection with FIG. 2, herein. When the calibration circuit detection is enabled, the calibration circuit can begin performing the operations described herein. For example, once the calibration circuit detection is enabled, the calibration circuit can detect a noise level associated with the display device. In some examples, the noise level can be detected by the calibration circuit as a change in noise level (e.g., a change from the base noise level exhibited by the display device to a noise level that corresponds to the display device being in a powered on state).

Subsequent to enablement of the calibration circuit detection, the calibration circuit can perform a calibration operation to calibrate a touchscreen (e.g., the touchscreen 104 illustrated in FIG. 1), etc. As described herein, the calibration operation can include calibrating the touchscreen based on the noise level exhibited by the display device. In some examples, the calibration operation can be performed between time t₂ and time t₃. For example, the calibration circuit can perform the calibration operation within a predetermined amount of time. By performing the calibration operation within the predetermined amount of time (e.g., between t₂ and time t₃), the calibration operation can be performed in a deterministic manner. Further, by performing the calibration operation within the predetermined amount of time, an amount of power consumed by the calibration circuit in performance of the calibration operation can be controlled.

FIG. 4 illustrates an example of a method 430 corresponding to a touchscreen calibration circuit consistent with the disclosure. The method 430 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some examples, the method 430 is performed by the calibration circuit 106 of FIG. 1. Although shown in a particular sequence or order, unless otherwise specified, the order of the processes can be modified. Thus, the illustrated examples should be understood only as examples, and the illustrated processes can be performed in a different order, and some processes can be performed in parallel. Additionally, some processes can be omitted in various examples. Thus, not all processes are utilized in every example. Other process flows are possible.

At block 432, the method 430 can include detecting, by a calibration circuit, a change in a noise level corresponding to a display device coupleable to the calibration circuit. In some examples, the calibration circuit can be analogous to the calibration circuit 106 illustrated in FIG. 1, herein, and the display device can be analogous to the display device 102 illustrated in FIG. 1, herein.

At block 434, the method 430 can include determining, by the calibration circuit, that a backlight status of the display device has been altered based on the detected change in the noise level. For example, the method 430 can include detecting, by the calibration circuit, that the display device has experienced a power on event as part of detecting the change in the noise level corresponding to the display device.

At block 436, the method 430 can include performing, by the calibration circuit, an operation to calibrate a touchscreen coupleable to the display device based on the determination that the backlight status of the display device has been altered. In some examples, the touchscreen can be analogous to the touchscreen 104 illustrated in FIG. 1, herein. In some examples, the method 430 can include determining, by the calibration circuit, that the backlight status of the display device has been altered in response to the display device experiencing a power on event. For example, in response to the display device being powered on, the calibration circuit can determine that the backlight status of the display device has been altered.

The method 430 can, in some examples, include performing, by the calibration circuit, an operation to calibrate a base reference capacitive sensing parameter corresponding to the touchscreen as part of performing the operation to calibrate the touchscreen. For example, if the touchscreen is a capacitive touchscreen (e.g., a touchscreen that uses the conductive touch of a human finger or a specialized device for input), the calibration circuit can perform the operation to calibrate the touchscreen to a base reference capacitive sensing parameter as part of the operation to calibrate the touchscreen. By calibrating the touchscreen to a base reference capacitive sensing parameter, the calibration circuit can effectively reset the sensitivity of the touchscreen each time the display device is power cycled, thereby optimizing the sensitivity and/or accuracy of the touchscreen.

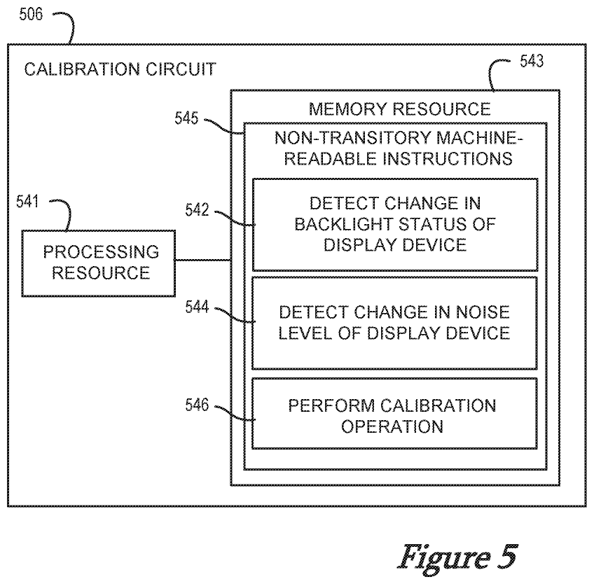

FIG. 5 illustrates an example of a calibration circuit 506 including a processing resource 541 and a memory resource 543 storing non-transitory machine-readable instructions 545 consistent with the disclosure. In some examples, the calibration circuit 506 can be analogous to the calibration circuit 106 illustrated in FIG. 1, herein.

The processing resource 541 may be a central processing unit (CPU), a semiconductor-based microprocessor, and/or other hardware devices suitable for retrieval and execution of non-transitory machine-readable instructions 545 stored in a memory resource 543. The processing resource 541 may fetch, decode, and execute the instructions 545. As an alternative or in addition to retrieving and executing the instructions 545, the processing resource 541 may include a plurality of electronic circuits (e.g., hard-coded logic circuitry, an application-specific integrated circuit, a field programmable gate array, etc.) that include electronic components for performing the functionality of the instructions 545.

The memory resource 543 may be any electronic, magnetic, optical, or other physical storage device that stores non-transitory machine-readable instructions 545 and/or data. Thus, the memory resource 543 may be, for example, a Random-Access Memory (RAM), a Read Only Memory (ROM), an Electrically-Erasable Programmable Read-Only Memory (EEPROM), a storage drive, an optical disc, and the like. The memory resource 543 may be disposed within the calibration circuit 506, as shown in FIG. 5. Additionally, the memory resource 543 may be a portable, external or remote storage medium, for example, that causes the calibration circuit 506 to download the non-transitory machine-readable instructions 545 from the portable/external/remote storage medium.

In some examples, the calibration circuit 506, the processing resource 541, and/or the memory resource 543 can operate in concert to carry out the operations described above in connection with FIGS. 1-4. For example, the calibration circuit 506, the processing resource 541, and/or the memory resource 543 can operate in concert to perform calibration operations for a touchscreen (e.g., the touchscreen 104 illustrated in FIG. 1, herein) based on detected changes in a state and/or status of a display device (e.g., the display device 102 illustrated in FIG. 1, herein).

For example, the processing resource 541 of the calibration circuit 506 can execute instructions 542 stored by the memory resource 543 to detect a change in a backlight status of a display device. As described above, the change in the backlight status of the display device can correspond to the display device being powered on from a powered off state or to the display device being powered off from a powered-on state.

In some examples, the processing resource 541 of the calibration circuit 506 can execute instructions 544 stored by the memory resource 543 to detect a change in a noise level of the display device. As describe above, the change in the noise level can correspond to the display device being powered on (e.g., to the backlight being activated) from a powered off state or to the display device being powered off (e.g., to the backlight being de-activated) from a powered on state.

In some examples, the processing resource 541 of the calibration circuit 506 can execute instructions 546 stored by the memory resource 543 to perform a calibration operation. As described above, the calibration operation can include establishing a relation between an amount of noise exhibited by a display device and behavior of a touchscreen to determine a correction factor to be applied to the touchscreen and applying the correction factor to the touchscreen to optimize the behavior of the touchscreen.

By performing the calibration operation using the calibration circuitry 506 described herein (e.g., calibration circuitry resident on the touchscreen), performance of the touchscreen may be enhanced in comparison to approaches that rely on instructions that are stored and/or executed using components that are resident on the display device. In addition, by performing the calibration operation using the calibration circuitry 506 described here, performance of the touchscreen may be enhanced in comparison to approaches that rely on disablement of clock signals processed by the display device during power cycling of the display device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 106 may refer to element 106 in FIG. 1 and an analogous element may be identified by reference numeral 506 in FIG. 5. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense. As used herein, the designators “M”, “N”, and “O”, particularly with respect to reference numerals in the drawings, indicate that a plurality of the particular feature so designated can be included with examples of the disclosure. The designators can represent the same or different numbers of the particular features.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a calibration circuit to:
determine a backlight status of a display device based on a detected difference in a noise level corresponding to the display device; and
perform an operation to calibrate a touchscreen coupleable to the display device based on the determined backlight status.

2. The apparatus of claim 1, wherein the calibration circuit is resident on the touchscreen.

3. The apparatus of claim 1, wherein the calibration circuit is further to determine the backlight status of the display device based on a change in a power state of the display device.

4. The apparatus of claim 1, wherein the calibration circuit operates in a first power mode while the backlight status of the display device is in a first state and a second power mode while the backlight status of the display device is in a second state.

5. The apparatus of claim 1, wherein the calibration circuit performs the operation to calibrate the touchscreen within a predetermined threshold time period after the backlight status is determined.

6. The apparatus of claim 1, wherein the operation to calibrate the touchscreen includes performance of an operation to calibrate a base reference capacitive sensing parameter corresponding to the touchscreen.

7. A system, comprising:
a liquid-crystal display device;
a touchscreen coupleable to the liquid-crystal display device; and
a calibration circuit resident on the touchscreen, wherein the calibration circuit is to:
determine that a change in a backlight status of the liquid-crystal display device has occurred; and
perform an operation to calibrate the touchscreen based on the determined change in the backlight status.

8. The system of claim 7, wherein the calibration circuit is to determine that the change in the backlight status of the liquid-crystal display device has occurred in response to a determination that a change in a power state of the liquid-crystal display device has occurred.

9. The system of claim 7, wherein the calibration circuit is to perform an operation to calibrate a base reference capacitive sensing parameter corresponding to the touchscreen as part of the operation to calibrate the touchscreen.

10. The system of claim 7, wherein the calibration circuit operates in a first power mode prior to the determination that the change in the backlight status of the liquid-crystal display device has occurred and operates in a second power mode subsequent to the determination that the change in the backlight status of the liquid-crystal display device has occurred.

11. The system of claim 7, wherein the calibration circuit is to determine that the change in the backlight status of the liquid-crystal display device has occurred based on detection of a change in a noise level corresponding to the liquid-crystal display device.

12. A method, comprising:
detecting, by a calibration circuit, a change in a noise level corresponding to a display device coupleable to the calibration circuit;
determining, by the calibration circuit, that a backlight status of the display device has been altered based on the detected change in the noise level; and
performing, by the calibration circuit, an operation to calibrate a touchscreen coupleable to the display device based on the determination that the backlight status of the display device has been altered.

13. The method of claim 12, comprising determining, by the calibration circuit, that the backlight status of the display device has been altered in response to the display device experiencing a power on event.

14. The method of claim 12, comprising performing, by the calibration circuit, an operation to calibrate a base reference capacitive sensing parameter corresponding to the touchscreen as part of performing the operation to calibrate the touchscreen.

15. The method of claim 12, comprising detecting, by the calibration circuit, that the display device has experienced a power on event as part of detecting the change in the noise level corresponding to the display device.
